(19) United States
(12) Patent Application Publication
(10) Pub. No.: US 2015/0276155 A1
(43) Pub. Date: Oct. 1, 2015

(54) Light Fixture

(71) Applicant: Hamid Rashidi Doust, Beverly Hills, CA (US)

(72) Inventor: Hamid Rashidi Doust, Beverly Hills, CA (US)

(21) Appl. No.: 14/226,590

(22) Filed: Mar. 26, 2014

(51) Int. Cl. F21S 8/04; F21V 23/02; F21V 7/00; F21V 5/04; F21K 99/00; F21V 29/50

(52) U.S. Cl. CPC F21S 8/04; F21K 9/17; F21V 29/50; F21K 9/50; F21V 7/0066; F21V 5/048; F21V 23/026; F21Y 2103/003

(57) ABSTRACT

Provided is an LED (light emitting diode) light fixture for hanging from a ceiling. The light fixture can be made from a plurality of bodies where LED strips are placed and ballast room(s) where ballasts are placed.

### BACKGROUND SECTION OF THE INVENTION

Light Emitting Diodes (“LED”) have become increasingly popular due to their low electricity usage. Light Emitting Diodes have begun replacing fluorescent lights in light fixtures.

A problem that exists with LED lights, particularly those that hang from a ceiling, is that they are not customizable to a particular need by a user. A user has to buy a specific fixture that cannot be customized. These LED lights also have to provide good lighting, heat dissipation, and be easy to maintain.

There is a need in the art to allow for a customizable LED light that hangs from a ceiling while at the same time providing good lighting, heat dissipation, and can be easily maintained.

### SUMMARY SECTION OF THE INVENTION

Provided is a light fixture comprising: a) one or more bodies as a separate component for placing LED (light emitting diode) light strips; b) one or more ballast rooms as a separate component for placing a ballast; c) an end frame as a separate component; wherein the fixture can be custom made by placing the body and the ballast room side by side in parallel fashion with each other to obtain a body-ballast room assembly with a desired number of bodies and ballast rooms, and attaching an end frame at each end of the body-ballast room assembly. The body and the ballast room can have a long side and a short side, and the body and the ballast room are attached to each other along the long side, with the short side of the body and the room together forming an end, wherein an end frame is attached to the end. The light fixture can comprise one body on each side of the ballast room (body-ballast room-body fixture). The ballast room can hold two ballasts. The body can have a horizontal portion on top against which the LED strip is placed. The body can have downwardly slanting portion on each side of the horizontal portion. The body can have a plurality of openings on each downwardly slanting portion of the body. The body can have a plurality of vents on each downwardly slanting portion of the body, The LED strip can be placed in between the body and a reflector, the reflector having openings though which light passes through, wherein the reflector covers the openings on the downwardly slanting portions. The body can be made of two cavities with each cavity capable of holding a single LED strip.

Provided is a light fixture for hanging comprising: a) a ballast room for placing ballasts, the ballast room comprised of a housing that is shape of a tube with an opening running along the tube for placing and removing ballasts; b) two bodies for placing LED light strips, the body having sides that run parallel with the LED strip, ends in perpendicular direction to the LED strip, a top comprised of a horizontal surface for placing LED strips inside the body and an opening on opposite side of the horizontal surface for light to travel; c) an end frame; d) one or more ballasts; e) a ballast housing cover that is placed on the ballast housing to enclose the tube; f) two lenses each placed on the opening of the bodies; wherein each body is placed side by side next to the ballast room with each body on one side of the ballast room and with the opening of the body and opening of the ballast housing running parallel to each other and pointing downward when hanging the light fixture; wherein end of the ballast housing and the end of the body in perpendicular direction to the openings together form a second end on each opposite side of the fixture, and the end frame is attached to each second end. The light fixture can further comprise a vanity frame attached to the end frame. The light fixture can further comprise a hanger attached to outside of the ballast housing on opposite side from the opening of the ballast housing. The light fixture can further comprise a plurality of hanging members projecting upwards from the end frame. The body can have downwardly slanting portion on each side of the horizontal portion, each has downwardly slanting portion having a plurality of openings and vents, wherein the LED strip is placed in between the body and a reflector, the reflector having openings though which light can pass through, and wherein the reflector covers the openings on the downwardly slanting portions.

Provided is a body for a light fixture that is hung from a ceiling comprising a first and a second cavity each having a first horizontal portion and a downwardly slanting portion on each side of the horizontal portion, the first and the second cavity joined together directly or by a second horizontal portion in a lower position In relation to the ceiling than the first horizontal portion, a vertical portion attached to side of the downward slanting portion that is not attached to the second horizontal portion, wherein all the portions are parallel to each other. The body can further comprise a plurality of openings and vents on each downwardly slanting portion of the body. The LED strip can be placed in between the body and a reflector, the reflector having openings though which LED lights are present, and wherein the reflector covers the openings on the downwardly slanting portions. The body can have an end panel for keeping wires outside of the interior of the body that is visible to a viewer. An upwardly projecting screw hole can be attached to each end of the second horizontal portion.

### BRIEF DESCRIPTION OF THE DRAWINGS

FIG. 1 illustrates a bottom perspective view of the body, reflector, and LED strip.

FIG. 2 illustrates a perspective view of the top of the body (1) that faces the ceiling.

FIG. 3 illustrates a side view of the body, which is a component of the light fixture where two LED strips are placed.

FIG. 4 illustrates a side view of the body, which is a component of the light fixture where two LED strips are placed.

FIG. 5 illustrates end view of body, which is a component of the light fixture where two LED strips are placed.

FIG. 6 illustrates end view of body, which is a component of the light fixture where two LED strips are placed.

FIG. 7 illustrates a top view of body, which is a component of the light fixture where two LED strips are placed.

FIG. 8 illustrates a bottom view of body with the LED strip and the reflector in place.

FIG. 9 illustrates a bottom perspective view of the body, which is a component of the light fixture where two LED strips are placed.

FIG. 10 illustrates a bottom perspective view of assembly ballast room.

FIG. 11 illustrates a top view of the assembly ballast room.

FIG. 12 illustrates a side view of the ballast room where two ballasts are placed.

FIG. 13 illustrates a side view of the ballast room where two ballasts are placed.

FIG. 14 illustrates an end view of the ballast room where two ballasts are placed.

FIG. 15 illustrates an end view of the ballast room where two ballasts are placed.

FIG. 16 illustrates a top view of the ballast room where two ballasts are placed.

FIG. 17 illustrates a top view of the cover for the assembly ballast room.

FIG. 18 illustrates a bottom perspective view of the ballast room.

FIG. 19 illustrates a top perspective view of the light fixture with the body and the assembly ballast room in place.

FIG. 20 illustrates a side view of the light fixture.

FIG. 21 illustrates a side view of the light fixture.

FIG. 22 illustrates an end view of the light fixture.

FIG. 23 illustrates an end view of the light fixture.

FIG. 24 illustrates a top view of the light fixture.

FIG. 25 illustrates a bottom view of the light fixture with lens in place.

FIG. 26 illustrates a bottom perspective view of the light fixture.

FIG. 27 illustrates a bottom perspective and exploded view of the light fixture with the parts of the fixture shown separately.

FIG. 28 illustrates a flow chart where a light fixture can be put together by choosing desired numbers of ballast housings and bodies.

### DETAILED DESCRIPTION OF THE INVENTION

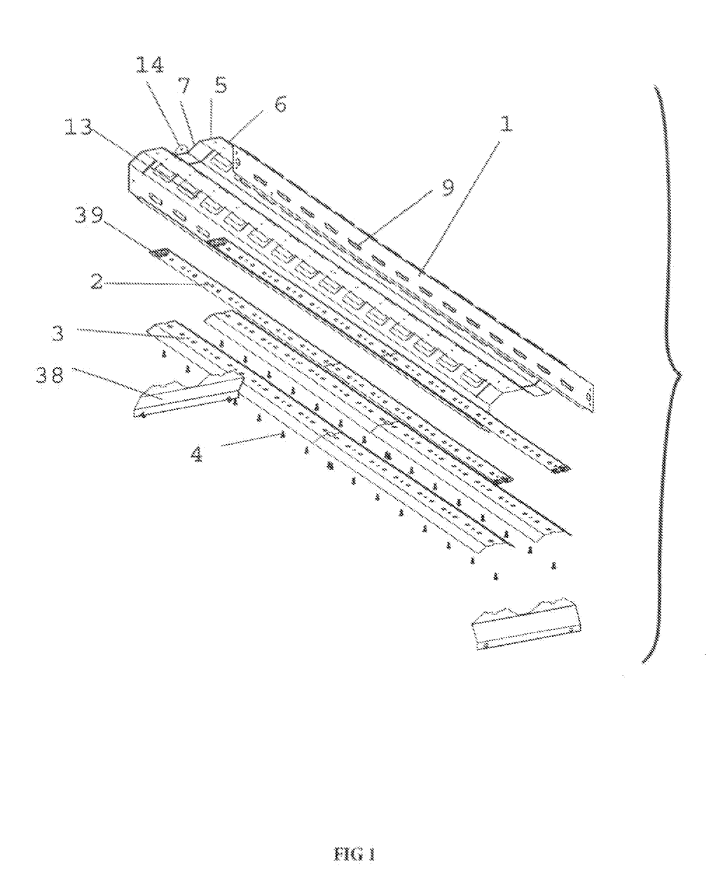

The present Invention provides a light fixture that is meant to replace the typical fluorescent light fixture that hangs from a ceiling. The light fixture is made from separate components, particularly a body (1) for placing LED strips (2), a ballast housing (20) and an end frame (36). A user can customize the amount of light generated by manipulating the numbers of bodies (1) and ballast housings (20) that are used, for example one configuration can have a ballast housing (20) with a body (1) on each side. When additional bodies (1) are needed, there may be a need for additional ballasts, and additional ballast, housings (20) can be added. An end frame (36) can be put at the end of the ballast housing (20) and body (1) assembly to further stabilize the assembly. Different sizes end frames (36) can be provided to a user. The body (1) can accept one or more LED strips (2) running parallel to each other. As shown in FIG. 1, this embodiment of the body (1) can hold two LED strips (2).

The light fixture of the present invention allows for superb heat dissipation. A plurality of vents (11) and corresponding vent openings (10) running along the sides allow for increased heat exchange and ability for the air to move in and out of the body. The vent openings (10) are designed to be covered by a reflector (3) that is placed on the LED strip (2). The placement of the reflector (3) blocks light from leaving from the vent openings (10), thus minimizing leakage of light from top of the fixture.

The light fixture of the present invention also allows accessing all components of the fixture from below the light fixture. A technician can replace ballasts and/or LED strips without taking the fixture off the ceiling. The LED strip in the body (1) is accessible by removing lens (16). The ballasts (25) and other electrical components are accessible by removing the ballast housing (20) cover (32). Access from under the fixture allows for a worker to maintain the fixture without taking the light fixture off from a ceiling.

FIG. 1 illustrates a body (1), two LED strips (2), and two reflectors (3) that would be fixed to each other by a fastener such as a screw (4). The LED strip (2) is placed against the inside horizontal portion (5) of the body (1), the reflector (3) is placed in the LED strip (2), and then the three pieces are screwed (4) together. Also shown is an end panel (38) that is put at the opposite ends of the body (1).

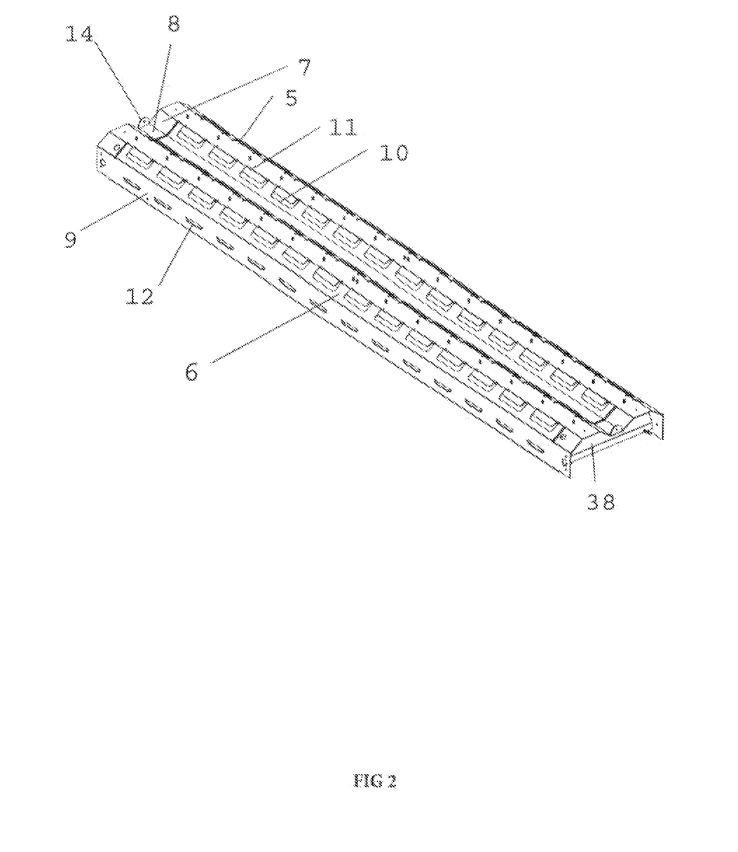

FIG. 2 is a perspective view of the top of the body (1) that faces the ceiling. In this embodiment, a body (1) is shown capable of receiving two separate LED strips (2) that can be placed in parallel to each other. In other words, the body that is illustrated has two cavities (13). Each cavity (13) is made from a top horizontal portion (5) against which the LED strip (2) is placed on the inside of the body (1). The top horizontal potion (5) is next to parallel downwardly slanting portions (6, 7) that are on both sides of the horizontal portion (5). The outside slanting portion (6) is joined to a vertical side opening (9) that runs parallel to the slanting portion (6, 7). Each cavity (13) can be joined to each other through a horizontal central portion (8) that runs parallel between each cavity. These different portions that make up the cavity (13) can be fabricated from one piece of metal or other material, or alternatively be fabricated from separate pieces and joined to each other. Suitable materials include metals such as aluminum or other metals. A member (14) with a screw hole (15) can project upward and can be placed at opposite ends of the body (1) at the central portion (8) for connection to the end frame (36). The downwardly slanting portions (6, 7) can have a plurality of openings (10) and a plurality of vents (11) at each opening (10). These vents (11) outwardly extend out at regular intervals. As shown in FIG. 2, the opening (10) and vent (11) are in rectangular shape with round corners. Other shapes such as square or circular can also be used. The opening (10) and vent (11) originate at the border between the horizontal portion (5) and the slanting portions (6, 7) and extend downward. The vents are connected to the border between the horizontal portion (5) and the slanting portions (6, 7), and descend at a smaller angle in relation to the slanting portions (6, 7). The vents (11) can be manufactured by cutting or perforating the slanting portions (6, 7) at regular intervals, and then raising upwardly the perforated or cut portions to obtain the vents (11). The side panel (9) can also have a plurality of openings (12) placed at regular intervals.

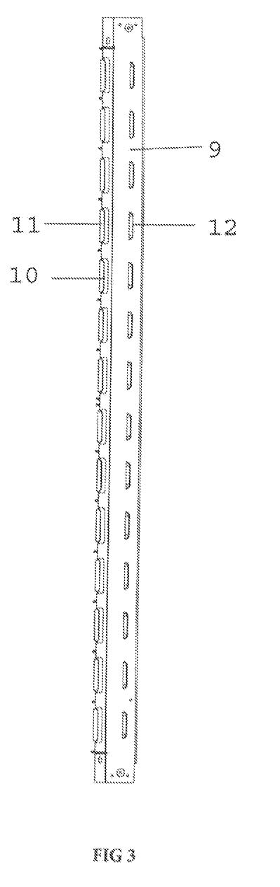

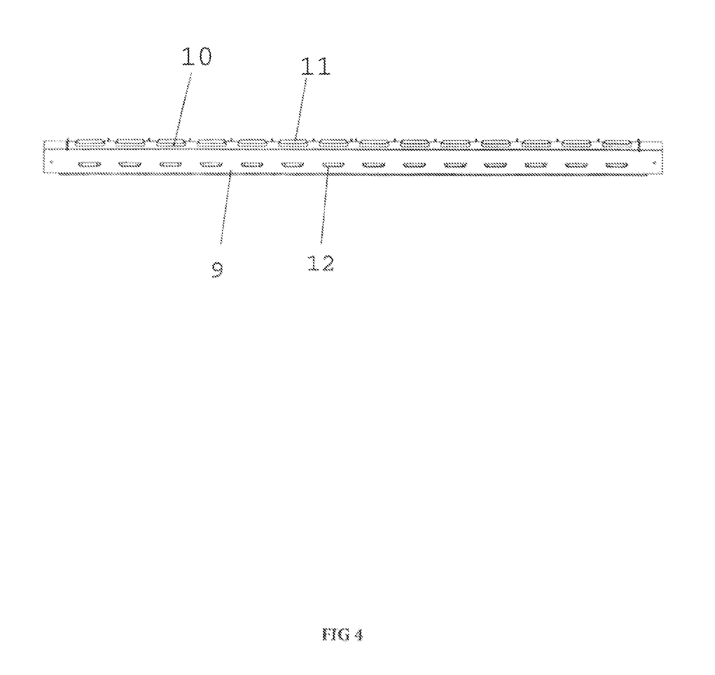

FIGS. 3 and 4 are side views of the body (1). The side panel (9) has a plurality of openings (12) at regular intervals. Also shown is the outside slanting portion (6) with openings (10) and vents (11) at regular intervals. FIG. 4 represents a view after a 180 degree rotation of the body of FIG. 3.

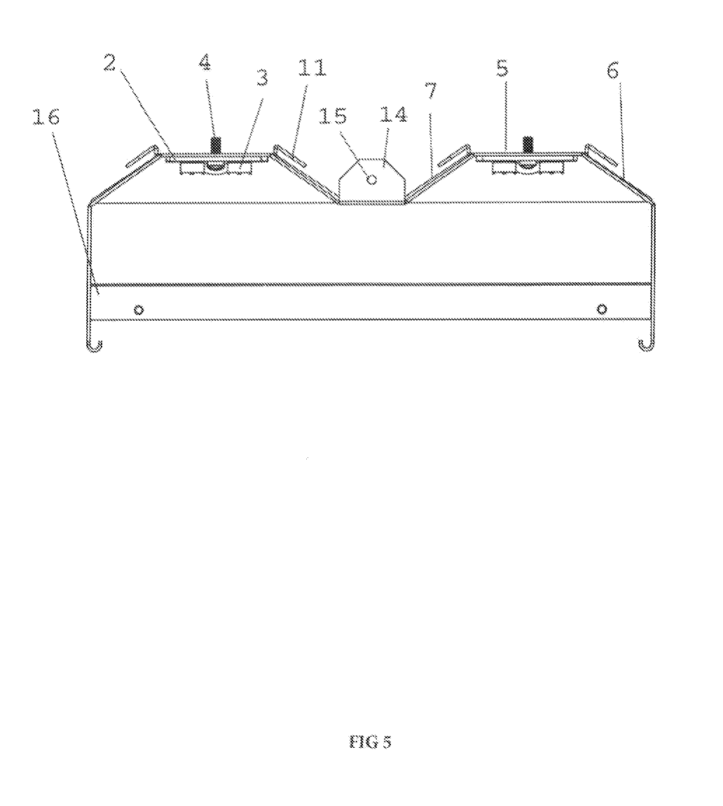

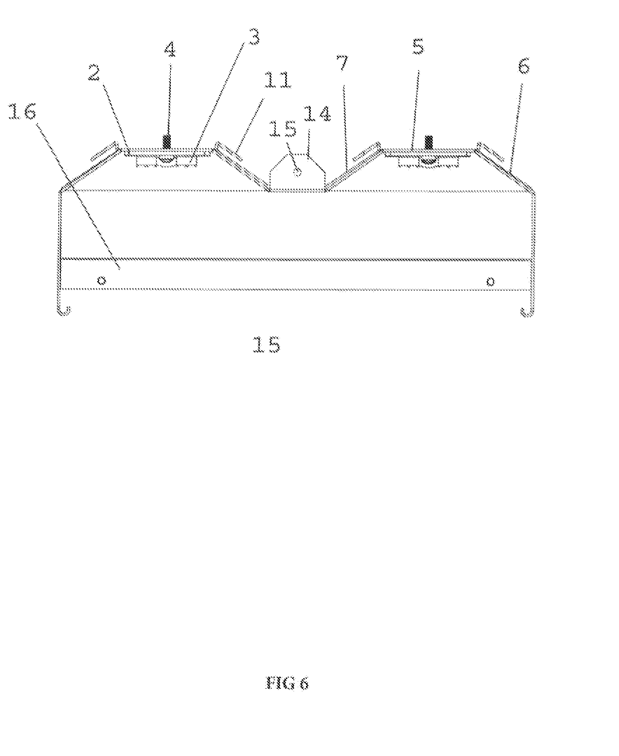

FIGS. 5 and 6 are end view of body (1). The body (1) is shown with vent (11) on the slanting portions (6) and (7). The LED strip (2) is placed against the horizontal portion (5) of the body (1). The reflector (3) is placed on the LED strip (2). The LED strip (2) is held in place in between the horizontal portion (5) of body (1) and the reflector (3) with a fastener such as a screw (4). A lens (16) such as that made from plastic or other material that light can pass through covers both cavities of the body. The lens (16) allows for both manipulating the light generated and forgiving a clean outwardly appearance. The member (14) extends up from the central horizontal portion (8) of the body and has a hole (15) for attaching to the end frame (36). FIG. 5 is represents a view after a 180 degree rotation of the body of FIG. 6.

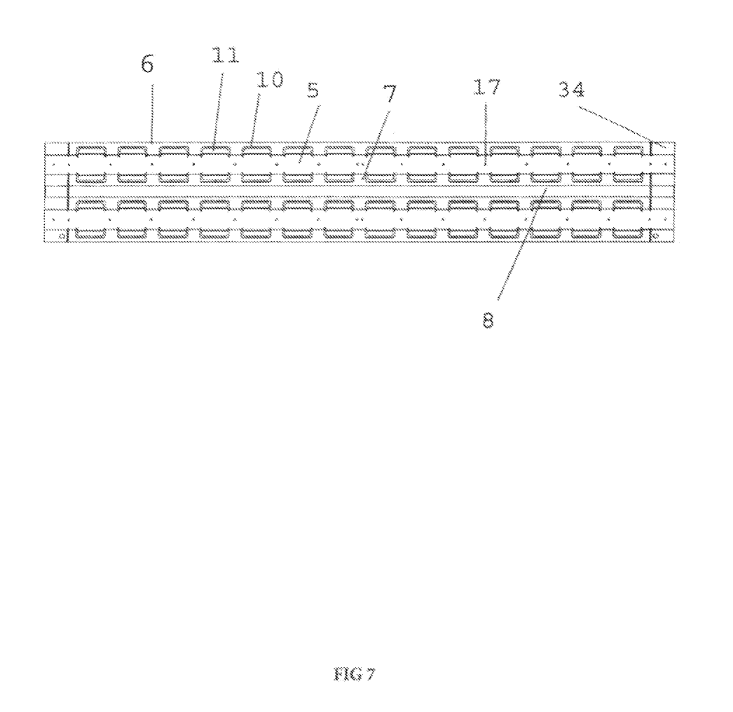

FIG. 7 is a top view of body (1). FIG. 7 shows the vents (11) and vent openings (12) at regular intervals on the slanting portions (6, 7) of the body. The screw holes (17) for screw (4) on the horizontal portion (5) are also illustrated, which are used for attaching the reflector (3) and the LED strip (2) to the body. The central horizontal portion (8) is also shown in the view, which connects the inside slanting (7) portions of each cavity of the body.

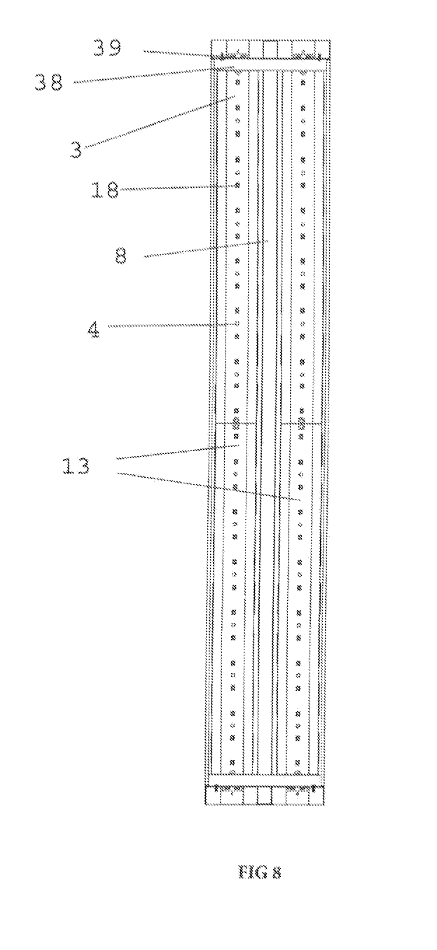

FIG. 8 is a bottom view of body (1) with the LED strip (2) and the reflector (3) in place. In this view, the LED strip (2) is being held in place by screw (4) behind the reflector (3). The LED light (18) is visible through the openings on the reflector (3). The openings on reflector (3) are designed to overlap with position of the LED lights (18) on the LED strip (2). FIG. 8 also shows that multiple strips can be placed one after each other in a single line as desired depending on the length of the body (1) and availability of the LED strip (2).

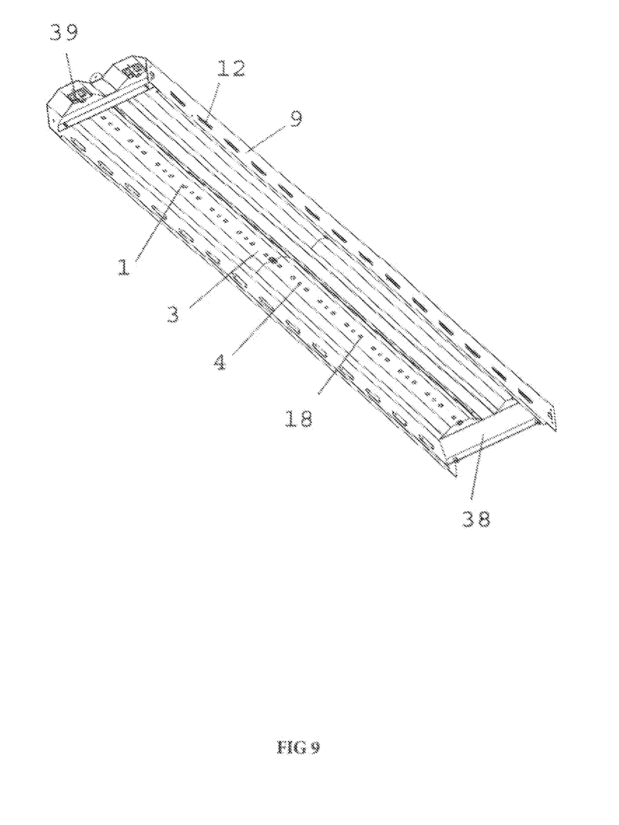

FIG. 9 is a bottom perspective view of the body (1). In this view, the LED strip (2) is being held in place by screw (4) behind the reflector (3). The LED light (18) is visible through the openings on the reflector (3). The openings on reflector (3) are designed to overlap with position of the LED lights (18) on the LED strip (2). Also visible in this view is the side panel (9) and its openings (12). An end panel (38) is placed at each end of the body and can provide an aesthetic look, The conductors (39) of the LED strip (2) are placed outside of the end panel for attachment to an electrical wire. The end panel (38) keeps the wires away from inside of the body (1) so a viewer cannot see the wires when looking up from the floor.

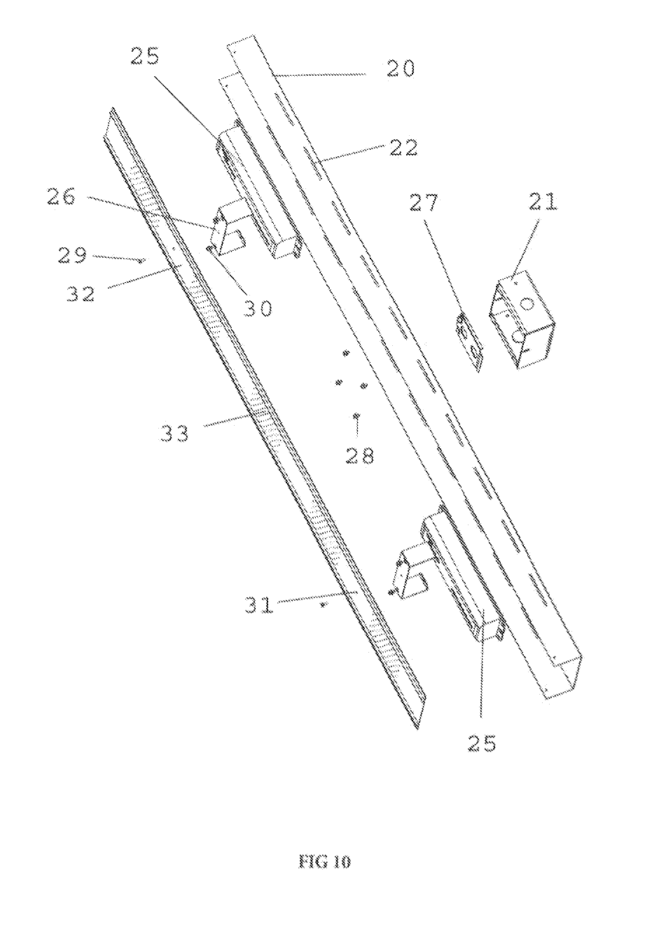

FIG. 10 is a bottom perspective view of assembly ballast room (40). Two ballasts (25) are placed in a ballast housing (20). Two brackets (26) and a fastener such as a screw (30) can be used to secure the ballast (25) to the ballast housing (20). Cover (32) with a plurality of openings (33) is placed on the ballast housing (20). Screw (29) or other similar fasteners or a rivet can be used to secure cover (32) to ballast (25) through a hole (31). An optional hanger (21) Is attached to the top of the ballast housing (20). The hanger (21) can be attached on top to a pipe carrying electrical wiring. Side hole (24) can be used if needed for wires. Also shown is a ballast housing top opening cover (2) which fits into an opening (the size of the cover) on the top of the ballast housing (20).

The ballast housing (20) shown in FIG. 10 is a rectangular tube with an open side. Square or other suitable shapes can also be used. Cover (32) is put on the opening to enclose the ballast room (40). When a technician needs to access the ballast room, the technician only needs to remove the cover (32).

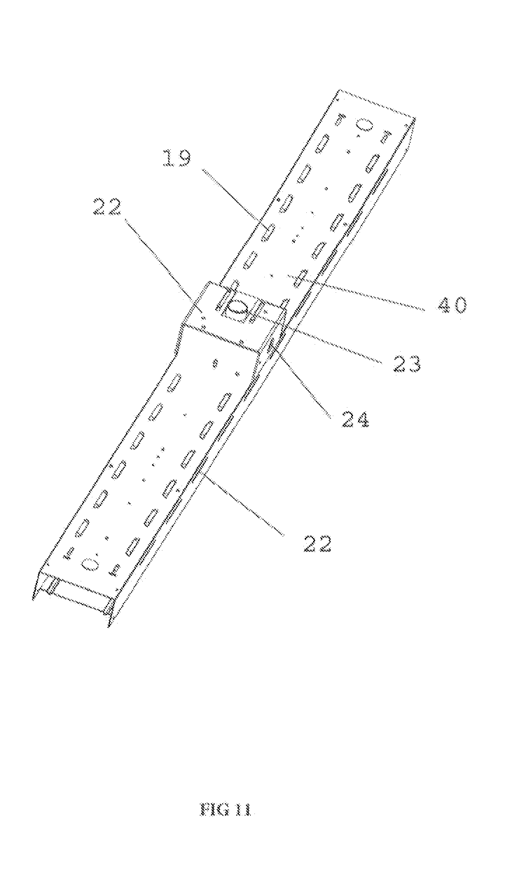

FIG. 11 is a top view of the assembly ballast room (40). The ballast room (40) can be made from a housing (20) and can have an optional hanger (21) attached to its top. The housing (20) can be substantially rectangular with a plurality of openings on the sides (22) and top (19) for to optimize air exchange and dissipation of heat. The hanger (21) Is shown with side hole (24) and pipe hole (23). The pipe hole can connect to a pipe that contains electrical wiring. The pipe can also be used to support the weight of the fixture. Alternatively, a conduit containing wires can be used and the weight of the fixture would be supported by a plurality of hang members (14). The hanger (21) is optional and the wiring can be directly connected to a ballast in the ballast room (40).

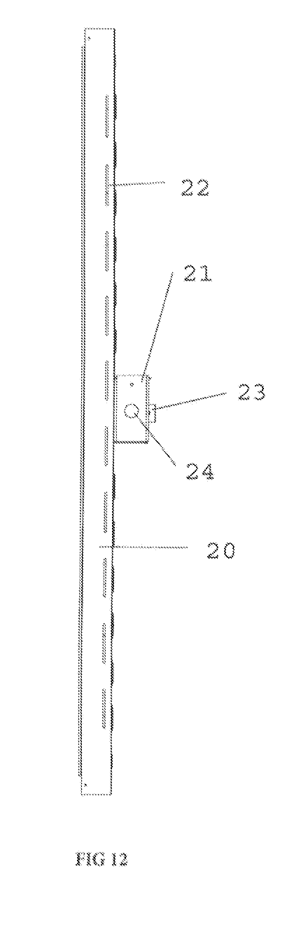

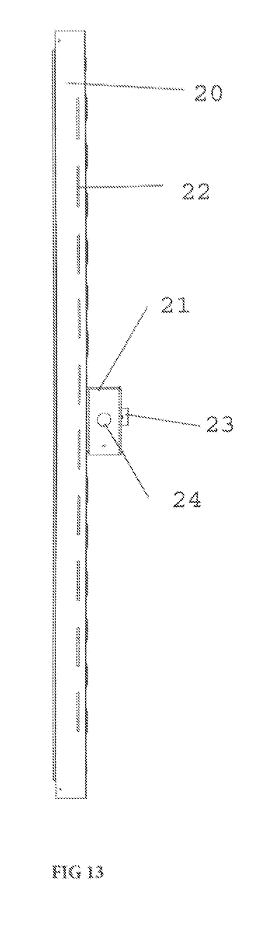

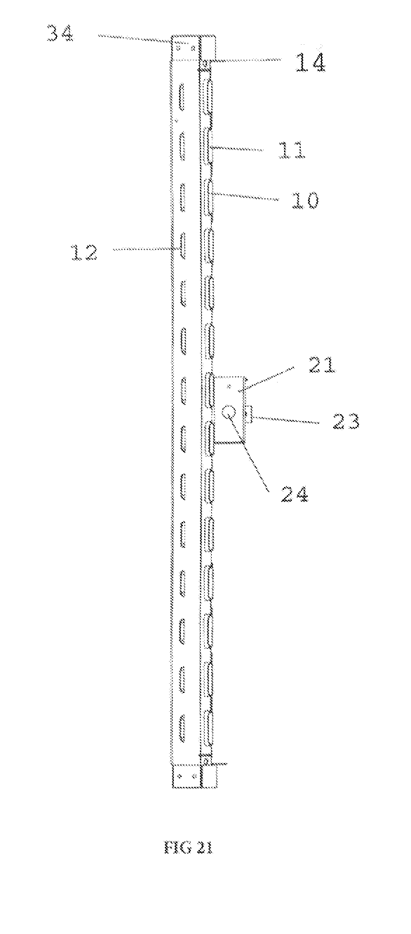

FIGS. 12 and 13 are side views of the ballast room (40). The hanger (21), which is optional, is on top of the ballast housing (20). The ballast housing (22) can have a plurality of openings on its sides. The hanger (21) is shown with side hole (24) and pipe hole (23) as described in FIG. 21. The drawing in FIG. 13 is a 180 degree rotation of the ballast room of FIG. 12.

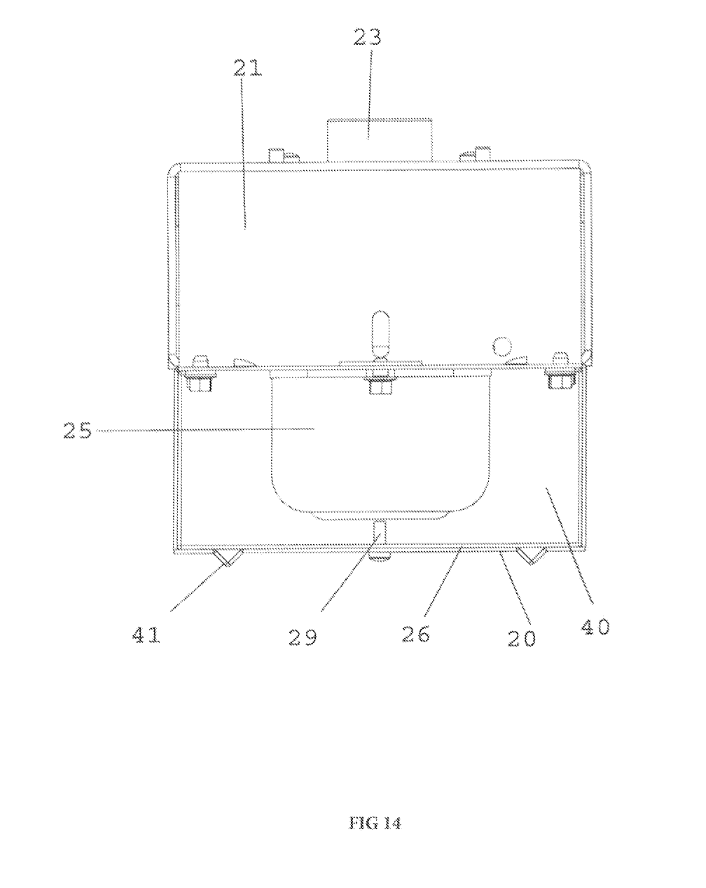

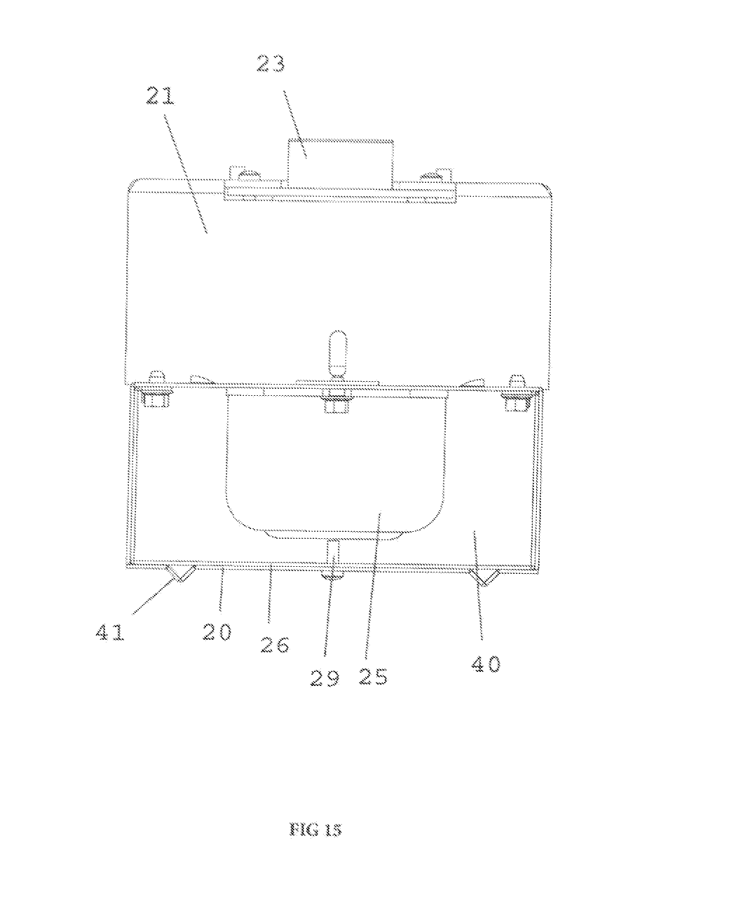

FIG. 14 illustrates an end view of the ballast room (40). The ballast room (40) is made from the ballast room housing (26) which is a rectangular tube with an open side and cover (32) which can have a raised surface (41). The raised surface (41) can both improve the aesthetic view of the cover (32) and increase the structural strength of the cover (42). The ballast (25) is attached to the cover (32) through bracket (26) and screw (29). The ballast (25) and the ballast housing (26) are attached to hanger (21) by several screws. Pipe hole (31) appears on top of hanger (21). The drawing in FIG. 15 is a 180 degree rotation of the ballast room of FIG. 14.

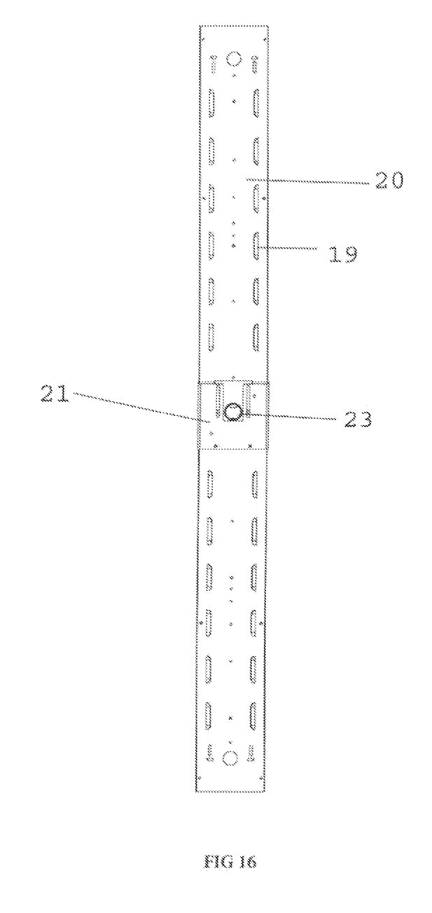

FIG. 16 is a top view of the ballast room (40). The ballast housing (20) is shown with hanger (21) is on top of the ballast housing (20), Also shown are the ballast housing top openings (19).

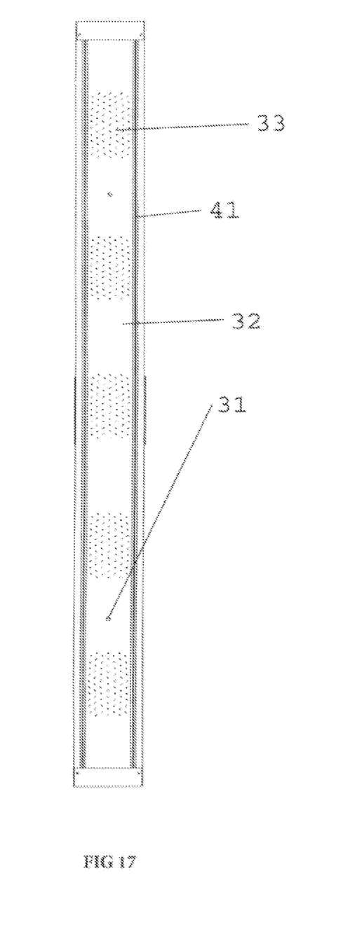

FIG. 17 is a top view of the cover (32) for the assembly ballast room, The cover can have a plurality of holes (33) for air to expedite air/heat exchange. The cover also has one or more holes (31) for attachment to a bracket (30). The cover also has a pair raised surfaces (41) running all along the cover in parallel to each other.

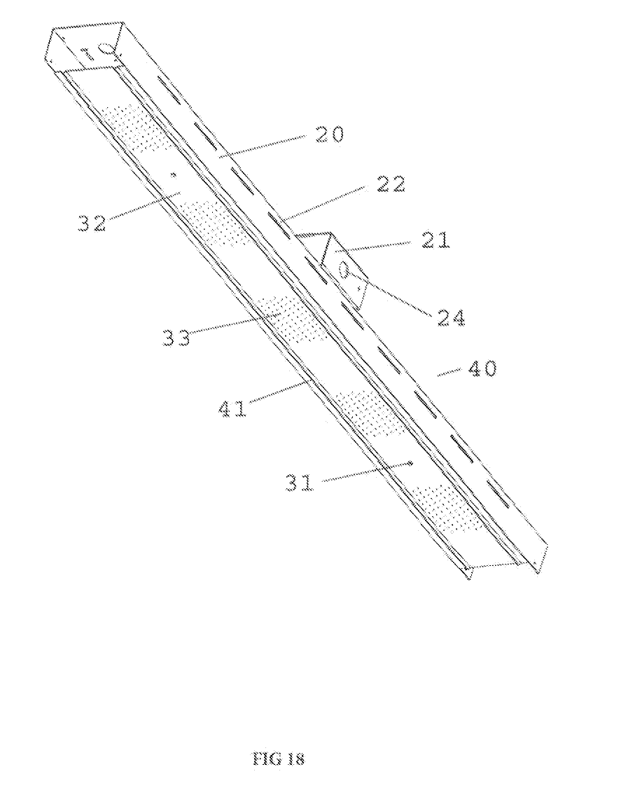

FIG. 18 is a bottom perspective view of the ballast room (20). The elements of the cover were discussed in respect to FIG. 17. The ballast housing (20) is shown with ballast housing side openings (22), hanger (21) on top of the ballast housing, and hanger side hole (24).

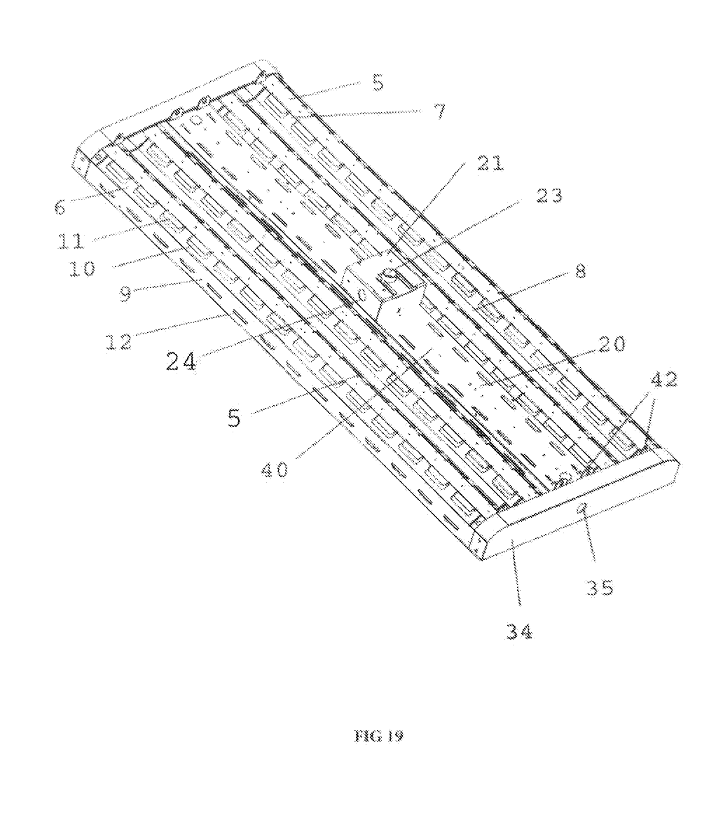

FIG. 19 provides a top perspective view of the light fixture with the assembly of a body (1) and the ballast room (40). In this embodiment, a body (1) with two cavities is placed on each side of the assembly ballast room (40). Vanity end panel (34) is used to cover the ends of the assembly to provide a fixture with a clean look. More specifically, a body (1) is placed on each side of the ballast room (40). The body (1) runs parallel with the ballast room (40). Hanger (21) with pipe hole (23) is placed on the ballast housing (20). Body (1) is shown with central portion (8), the outside and inside slanting portions (6, 7), vents (11), and vent openings (10). Also shown are the vanity end panels (34) and the hang members (14) for hanging the fixture to a ceiling.

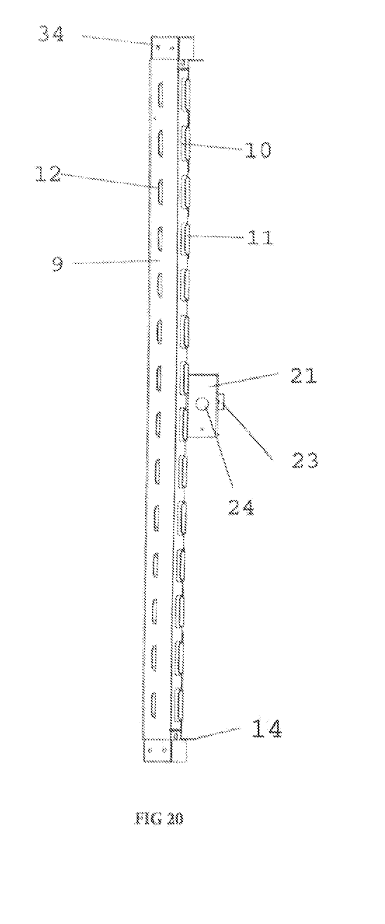

FIGS. 20 and 21 are side view of the fixture. The hanger (21) is on top of the ballast housing (20). The body (1) is shown with vent (11) on the outside slanting portion (6). A hanging member (14) such as with a hole (15) can be placed at opposite ends of the body (1). The downwardly slanting portions (6) have a plurality of openings (10) and a plurality of vents (11) at each opening (10). These vents (11) outwardly extend out at regular intervals. The side panel (9) can have a plurality of openings (12) placed at regular intervals. The drawing in FIG. 21 is a 180 degree rotation of the fixture of FIG. 20.

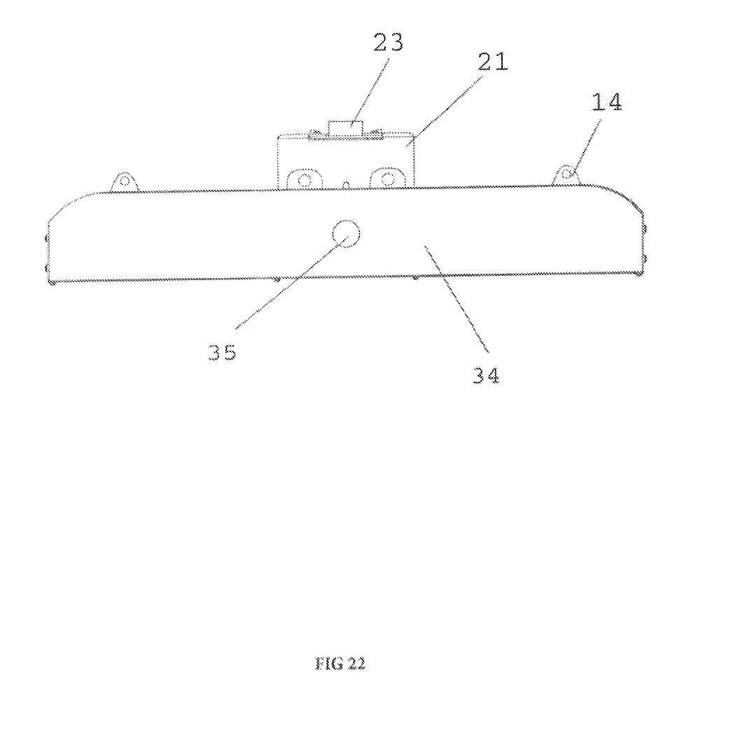

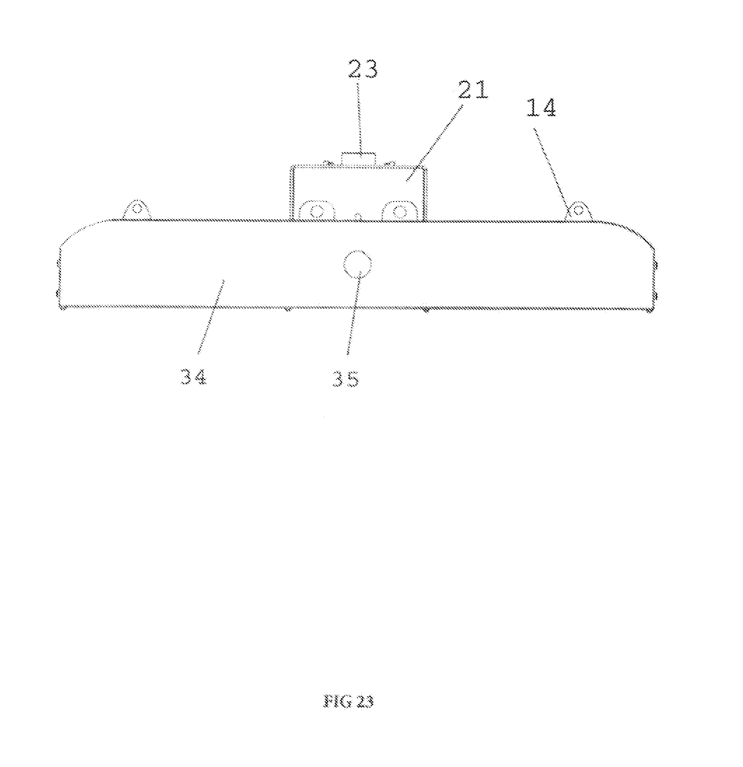

FIGS. 22 and 23 are end views of the light fixture. Vanity end panel (34) covers the end of the fixture, Hanger (21) is shown with a top screw hole (23) for attachment of a pipe. A hang member (14) such as with a hole (15) are on the end frames (36) (which is covered by vanity end panel (34)). After attaching the end frames (36), the hanging members (14) stick out at opposite ends of the light fixture. The drawing in FIG. 23 is a 180 degree rotation of the fixture of FIG. 22.

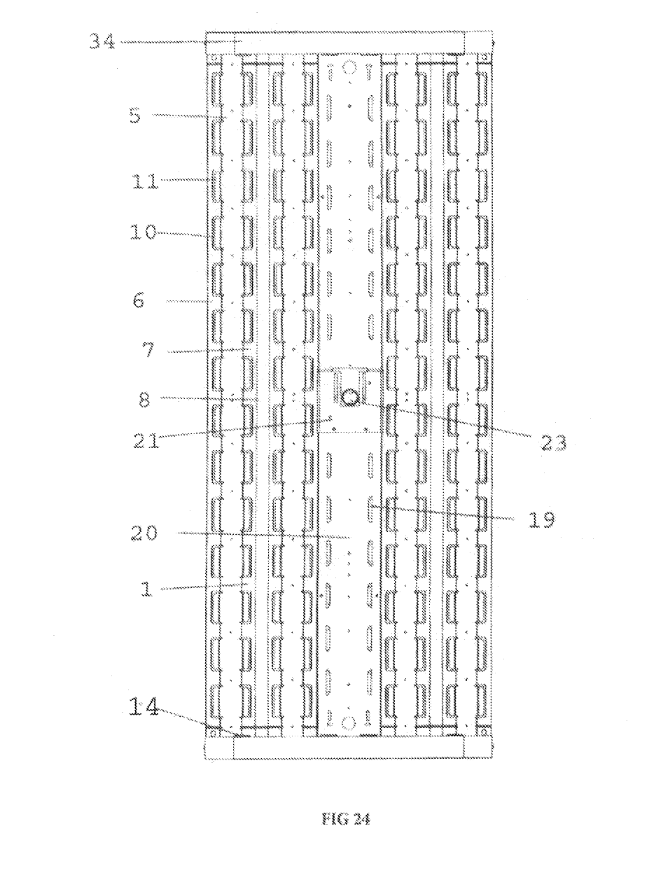

FIG. 24 is a top view of the fixture, in this embodiment, a body (1) is placed on each side of the ballast housing (20). Hanger (21) with pipe hole (23) is placed on the ballast housing (20). Body (1) is shown with central portion (8), the outside and inside slanting portions (6, 7 ), vents (11), and vent openings (10). Also shown are the vanity end panels (34) and the hang members (14) for hanging the fixture to a ceiling.

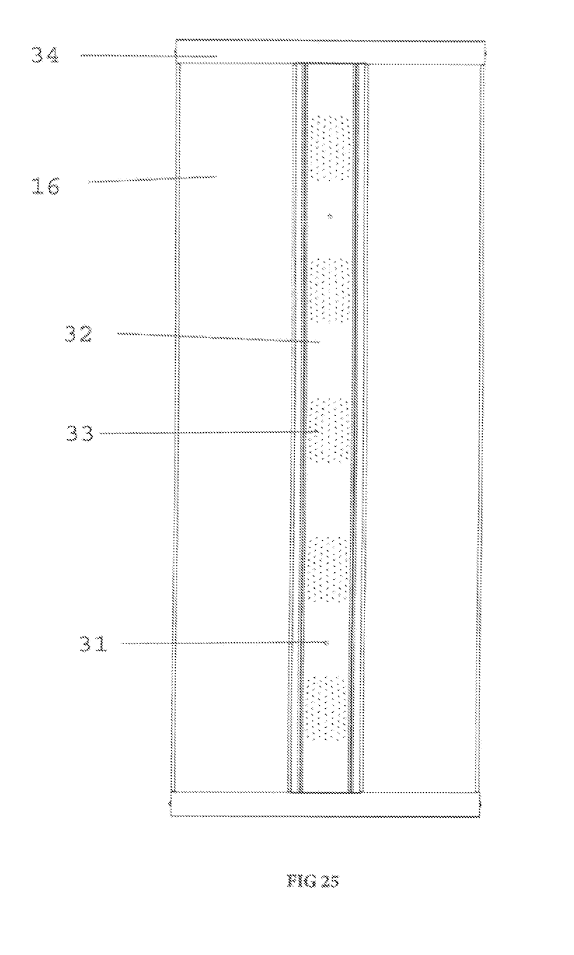

FIG. 25 is a bottom view of the fixture with lens (16) in place. Lens (16) can be any type of synthetic material (plastic) that is suitable for a desired lighting condition. Ballast cover (32) is in middle of the two lenses (16), and run substantially parallel to each other. The cover (32) has plurality of holes or openings (33) for exchange of air and a screw hole (31) for keeping cover (32) in place. The vanity end panel (34) covers the end frame (36) (not shown) which keeps the fixture together.

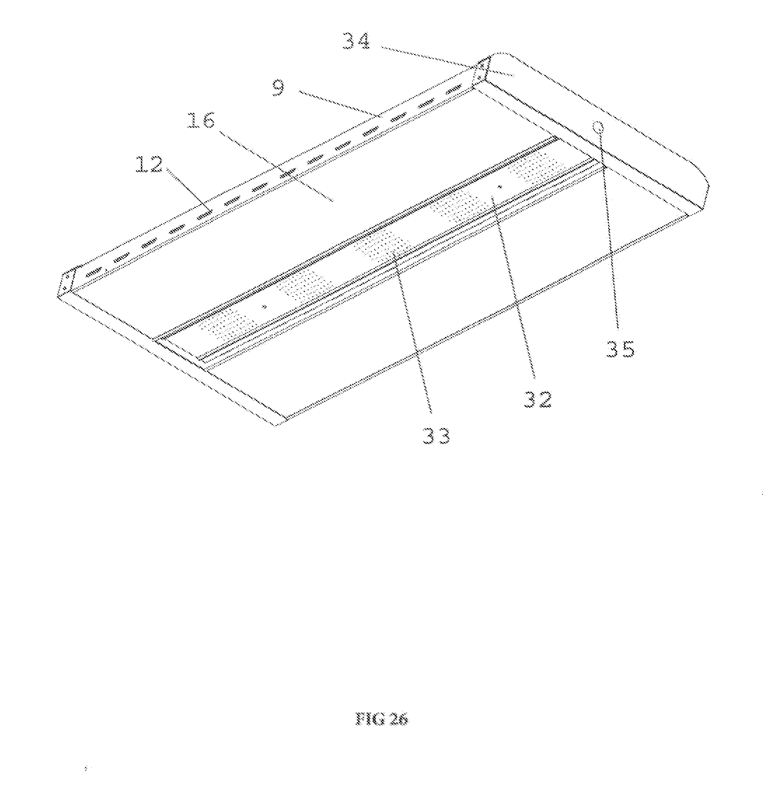

FIG. 26 is a bottom perspective view of the fixture. The same portion as FIG. 25 are seen in addition to end hole (37) which can be used for passage of wires when multiple light fixtures are electronically connected to each other. Also shown is side panel (9) with a plurality of openings (12).

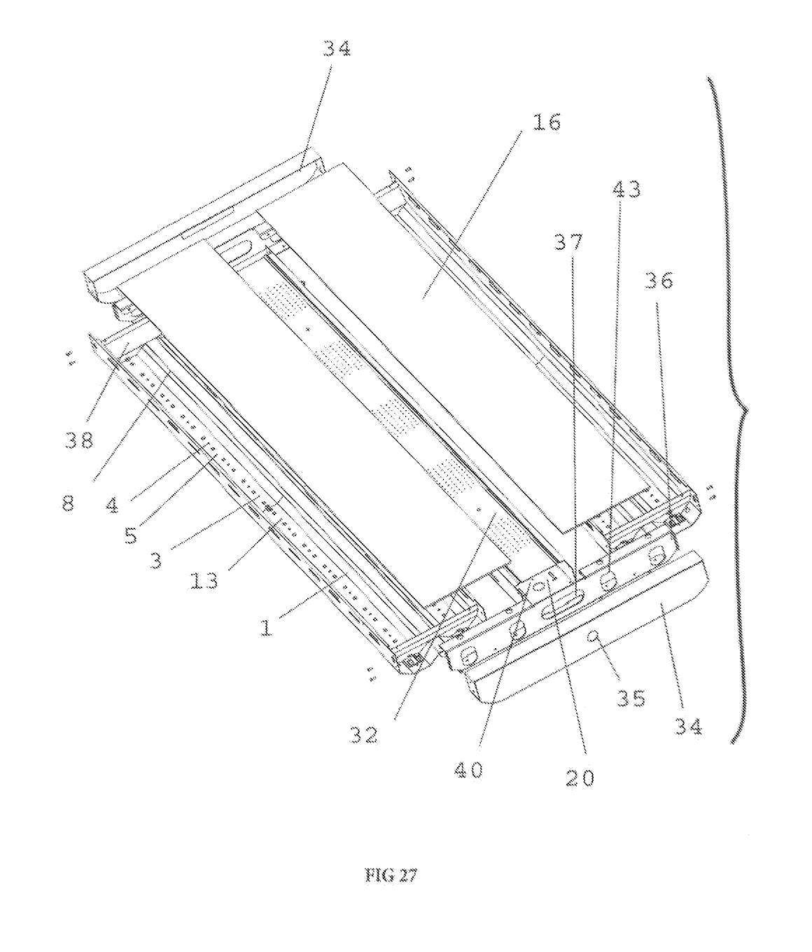

FIG. 27 is a bottom perspective view of the light fixture with all the portions shown separately. Two bodies (1) are shown on each side the ballast room (40) which is illustrated with the ballast housing (20) and ballast cover (32). The ballast cover is shown with a plurality of holes (33) to allow for air exchange. The body (1) is shown with LED (18) of LED strip (2) and reflector (3) which is attached to the body via screw (4). The end frame (36) is used to attach and stabilize the body (1) and the ballast room housing (32) together. A vanity end panel (34) is placed on the end frame (36) for aesthetic reasons. Wires (not shown) pass from the opening at end of the ballast room to inside the space between the vanity end panel (34) and the end frame (36). and the wires then go inside the body (1) through another opening on the end panel (34). The wires are all covered by the vanity end panel (34) and are not visible when looking at the fixture. Additionally, the LED strip conductors (39) are isolated from inside of the body with the end panel (38), further providing a fixture with a clean look where wires are not visible when looking at the fixture. A lens (16) is placed on each body.

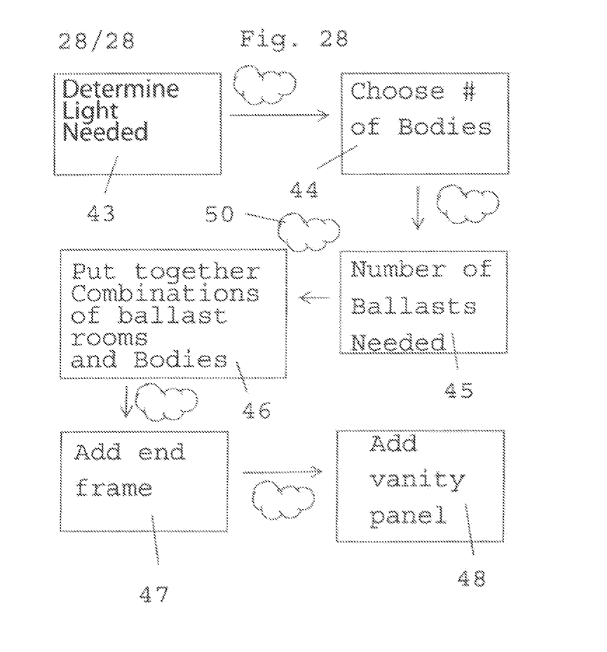

The present invention also provides a method for customizing a light fixture as desired by a user, for example as illustrated in FIG. 28. A first determination is made as to how much light needed (43), which can depend on one or more factors such as the size of a room for installation of the light, the number of LED strips, length of LED strips, number of LED lights on the strip, and the type of fens. After a determination of how much light is needed, a user selects the number of bodies that is needed (44) or a computer system does the calculation and suggests the number of bodies that are needed. To facilitate the choice, a standard body and/or LED light strip choice can be provided, so the user or the computer system has to only choose how many bodies it needs. After the number of bodies are chosen, a determination is made as the number of ballasts needed based on the power consumption (45). This determination can also be made by a computer system. After determining how many ballasts are needed, the proper number of ballast rooms are chosen. The light fixture is then assembled with the desired number of ballast rooms and bodies in parallel to each other (46). An end frame can then be added (47). Different sizes of end frames can be provided and attached depending on the final ballast room-body combination. An optional vanity panel (48), also with different sizes, can also be attached. Other optional features include a lens and a protective cage.

The mentioned above method can be a computer implemented method with a website that offers customization of the light fixture. The steps including one or more of determining/inputting how much light is needed (43), choosing number of bodies (44), choosing number of ballast rooms (45), and choosing the final fixture (45). These steps can be carried out by a computer system or a processes and the instructions can be carried out over a communication network (50), such as the internet.

The following are some examples of body(1)—ballast housing combinations with the body holding anywhere from one to five LED light strips, such as one to two LED light strips, such as two LED light strips;
Body-Ballast-Body-[Body-Ballast-Body]
Body-Ballast-Body-ballast-Body-
Body-body-Ballast-Body-Body
Body-Ballast-Body-body-ballast-body

### REFERENCE TO NUMBERS

1. body
2. LED Strip
3. reflector
4. screw
5. horizontal portion
6. Outside Slant
7. Inside Slant
8. Central portion
9. Side panel
10. Vent opening
11. vent
12. Side Panel openings
13. cavity
14. projecting hang member
15. screw hole
16. lens
17. screw hole
18. LED light
19. ballast housing top openings
20. ballast housing
21. hanger
22. ballast housing side openings
23. pipe hole
24. hanger side hole
25. ballast
26. brackets
27. top cover
28. screw
29. screw
30. screw
31. hole
32. cover
33. plurality of openings on cover
34. vanity end panel
35. Vanity end hole
36. end frame
37. End wire hole
38. End panel
39. Conductors
40. Ballast room
41. Raised surface on cover
43. Side end wire hole
43-49 (steps of FIG. 28),
50. Communication network

What is claimed is:

1. A fight fixture comprising:
a) one or more bodies as a separate component for placing LED (light emitting diode) light strips;
b) one or more ballast rooms as a separate component for placing a ballast;
c) an end frame as a separate component;
wherein the fixture can be custom made by placing the body and the ballast room side by side in parallel fashion with each other to obtain a body-ballast room assembly with a desired number of bodies and ballast rooms, and attaching an end frame at each end of the body-ballast room assembly.

2. The light fixture of claim 1, wherein the body and the ballast room have a long side and a short side, and the body and the ballast room are attached to each other along the long side, with the short side of the body and the room together forming an end, wherein an end frame is attached to the end.

3. The light fixture of claim 1, wherein the light fixture comprises one body on each side of the ballast room (body-ballast room-body fixture).

4. The light fixture of claim 3, wherein the ballast room holds two ballasts.

5. The light fixture of claim 1, wherein the body has a horizontal portion on top against which the LED strip is placed.

6. The light fixture of claim 5, wherein the body has downwardly slanting portion on each side of the horizontal portion.

7. The light fixture of claim 6, further comprising a plurality of openings on each downwardly slanting portion of the body.

8. The light fixture of claim 7, further comprising a plurality of vents on each downwardly slanting portion of the body.

9. The light fixture of claim 6, wherein the LED strip is placed in between the body and a reflector, the reflector having openings though which light passes through, wherein the reflector covers the openings on the downwardly slanting portions.

10. The light fixture of claim 1, wherein the body is made of two cavities with each cavity capable of holding a single LED strip.

11. A light fixture for hanging comprising:
a) a ballast room for placing ballasts, the ballast room comprised of a housing that is shape of a tube with an opening running along the tube for placing and removing ballasts;
b) two bodies for placing LED light strips, the body having sides that run parallel with the LED strip, ends In perpendicular direction to the LED strip, a top comprised of a horizontal surface for placing LED strips inside the body and an opening on opposite side of the horizontal surface for light to travel;
c) an end frame;
d) one or more ballasts;
e) a ballast housing cover that is placed on the ballast housing to enclose the tube;
f) two lenses each placed on the opening of the bodies;
wherein each body Is placed side by side next to the ballast room with each body on one side of the ballast room and with the opening of the body and opening of the ballast housing running parallel to each other and pointing downward when hanging the light fixture;
wherein end of the ballast housing and the end of the body in perpendicular direction to the openings together form a second end on each opposite side of the fixture, and the end frame is attached to each second end.

12. The light fixture of claim 11, further comprising a vanity frame attached to the end frame.

13. The light fixture of claim 11, further comprising a hanger attached to outside of the ballast housing on opposite side from the opening of the ballast housing.

14. The light fixture of claim 11, further comprising a plurality of hanging members projecting upwards from the end frame.

15. The light fixture of claim 11, wherein the body has downwardly slanting portion on each side of the horizontal portion, each has downwardly slanting portion having a plurality of openings and vents, wherein the LED strip is placed in between the body and a reflector, the reflector having openings though which light can pass through, and wherein the reflector covers the openings on the downwardly slanting portions.

16. A body for a light fixture that is hung from a ceiling comprising a first and a second cavity each having a first horizontal portion and a downwardly slanting portion on each side of the horizontal portion, the first and the second cavity joined together directly or by a second horizontal portion in a lower position in relation to the ceiling than the first horizontal portion, a vertical portion attached to side of the downward slanting portion that is not attached to the second horizontal portion, wherein all the portions are parallel to each other.

17. The body of claim 16, farther comprising a plurality of openings and vents on each downwardly slanting portion of the body.

18. The body of claim 16, wherein the LED strip is placed in between the body and a reflector, the reflector having openings though which LED lights are present, and wherein the reflector covers the openings on the downwardly slanting portions.

19. The body of claim 16, wherein the body has end panel for keeping wires outside of the interior of the body that is visible to a viewer.

20. The body of claim 16, wherein an upwardly projecting screw hole is attached to each end of the second horizontal portion.
